(19) United States
(12) Patent Application Publication
(10) Pub. No.: US 2015/0236851 A1
(43) Pub. Date: Aug. 20, 2015

(54) METHOD AND APPARATUS FOR UPDATING CA PUBLIC KEY, UE AND CA

(71) Applicant: Huawei Technologies Co., Ltd., Shenzhen (CN)

(72) Inventors: Xiaoyu Bi, Shenzhen (CN); Jing Chen, Shenzhen (CN); Yixian Xu, Shenzhen (CN); Chunshan Xiong, Shenzhen (CN)

(21) Appl. No.: 14/706,432

(22) Filed: May 7, 2015

Related U.S. Application Data
(63) Continuation of application No. PCT/CN2012/084220, filed on Nov. 7, 2012.

(51) Int. Cl. H04L 9/08; H04L 9/30

(52) U.S. Cl. CPC H04L 9/0825; H04L 9/30; H04L 2209/64; H04L 2209/24

(57) ABSTRACT

A method and an apparatus for updating a public key, a UE and a CA are disclosed. The method includes: receiving a first message including CA public key information, where the CA public key information includes a CA public key or CA public key acquiring information; and updating a local CA public key of a UE according to the CA public key or to the CA public key acquiring information. The present invention can realize update of the CA public key in the UE.

### CROSS-REFERENCE TO RELATED APPLICATIONS

This application is a continuation of International Application No. PCT/CN2012/084220, filed on Nov. 7, 2012, which is hereby incorporated by reference in its entirety.

### TECHNICAL FIELD

The present invention relates to communications, and more particularly, to a method and an apparatus for updating a CA public key, a UE and a CA.

### BACKGROUND

A public warning system (PWS) is a public warning system for warning a natural disaster or an accident due to human error possible to cause losses to our lives and property. The natural disaster includes flood, hurricane and the like, and the man-made accident includes chemical gas leakage, explosion threat, nuclear threat and the like. When the natural disaster or the accident due to human error occurs, the PWS, serving as a supplement to an existing broadcast communication system, sends a PWS warning message to a user equipment (UE), so as to warn a subscriber. PWS service is provided by a telecom operator to subscribers, and specific contents of the PWS service may be provided by a warning notification provider. When some events occur, the warning notification provider generates a warning message (warning notification) and provides the same to the telecom operator. The telecom operator sends a PWS warning message to a UE by using a telecom network, so as to warn the subscriber. Since issue of the PWS warning message may trigger mass panic, requirement on security is relatively high. According to security requirement of the PWS, a security mechanism shall prevent false warning notification, protect integrity of a PWS warning message and identify a sending source of a PWS warning message.

PWS public warning security becomes a hot area of research in SA3 group of 3GPP standard organization, and different equipment manufacturers propose different security solutions. A soltuion assumption based on an implicit certificate is discussed in the sixty-seventh conference of the SA3 standard, a specific solution is discussed in the sixty-eighth conference, and the solution becomes one of alternative PWS security solutions in TR 33.869 by discussion. A specific implementation method of the solution based on the implicit certificate is as follows: deploying multiple global certification authorities (CA) wordwide to serve as secure initial nodes of the PWS, and moreover, pre-configuring a public key of these global CAs in a UE; acquiring, by a cell broadcast entity (CBE), an implicit certificate from a global CA periodically; and when a public warning event occurs, broadcasting, by the CBE, a PWS warning message to the locality of the warning event through a cell broadcast center (CBC), where the PWS warning message includes message content and security part, and the security part contains a signature of the CBE and an implicit certificate; and after the PWS warning message is received, calculating, by a UE, a public key of the CBE by using a CA public key stored locally in combination with the implicit certificate in the PWS warning message, and verifying a signature of the CBE in the PWS warning message through the public key of the CBE, thereby identifying whether the received PWS warning message is a legal public warning message.

In the solution based on the implicit certificate, the CA public key pre-configured in a UE is a basis for verifying whether a PWS warning message is a legal public warning message. Therefore, ensuring correctness of the CA public key stored in the UE is one of the key points of the solution.

Although a period of validity of a CA public key is generally 15-20 years, due to some reasons, such as, for example, damage of a private key corresponding to the public key, expired public key and/or the like, it is nessary to update the CA public key configured in the UE in time. However, there does not exist a technical solution for updating the CA public key configured in the UE been disclosed for now.

### SUMMARY

Embodiments of the present invention provide a method and an apparatus for updating a CA public key, a UE and a CA, which can realize update of a CA public key configured in a UE.

In a first aspect, a method for updating a CA public key is provided, including:

receiving a first message including CA public key information, where the CA public key information includes a CA public key or CA public key acquiring information; and

updating a local CA public key of a UE according to the CA public key or to the CA public key acquiring information.

In combination with the above-mentioned first aspect, in a first possible implementation manner, before the receiving a first message, the method further includes:

sending a certificate request message in a CMPv2 protocol to a CA, where a certificate requested by the certificate request message is a CA public key; and

the receiving a first message including CA public key information includes:

receiving a certificate response message in the CMPv2 protocol sent by the CA, where the certificate response message includes the CA public key information.

In combination with the above-mentioned first aspect, and/or the first possible implementation manner, in a second possible implementation manner, the receiving a first message including CA public key information, includes:

receiving a CA public key update message sent by a CA, where the update message includes the CA public key information.

In combination with the above-mentioned first aspect, and/or the first possible implementation manner, and/or the second possible implementation manner, in a third possible implementation manner, the receiving a first message including CA public key information, includes:

receiving a PWS warning message broadcasted by a CBE through a CBC, where the PWS warning message includes the CA public key information, and the CA public key information is sent from a CA to the CBE.

In combination with the above-mentioned first aspect, and/or the first possible implementation manner, and/or the second possible implementation manner, and/or the third possible implementation manner, in a fourth possible implementation manner, the CA public key or the CA public key acquiring information is carried by an SIB, or carried by contents of the PWS warning message, or carried by a security information element in the PWS warning message.

In combination with the above-mentioned first aspect, and/or the first possible implementation manner, and/or the second possible implementation manner, and/or the third possible implementation manner, and/or the fourth possible implementation manner, in a fifth possible implementation manner, the CA public key information further includes a CA public key update instruction, the CA public key update instruction being carried by a type information element in the PWS warning message, or carried by four idle bytes in the PWS warning message, or carried by a security information element in the PWS warning message, or carried by an SIB.

In combination with the above-mentioned first aspect, and/or the first possible implementation manner, and/or the second possible implementation manner, and/or the third possible implementation manner, and/or the fourth possible implementation manner, and/or the fifth possible implementation manner, in a sixth possible implementation manner, the CA public key information further includes related information of a CA public key, and the related information of the CA public key includes an ID of the CA public key and/or a period of validity of the CA public key, where the related information of the CA public key is carried by a type information element in the PWS warning message, or carried by four idle bytes in the PWS warning message, or carried by a security information element in the PWS warning message, or carried by an SIB, or carried by contents of the PWS warning message.

In combination with the above-mentioned first aspect, and/or the first possible implementation manner, and/or the second possible implementation manner, and/or the third possible implementation manner, and/or the fourth possible implementation manner, and/or the fifth possible implementation manner, and/or the sixth possible implementation manner, in a seventh possible implementation manner, the receiving a first message including CA public key information, includes:

receiving an NAS message sent by a core network entity, where the NAS message includes the CA public key information.

In combination with the above-mentioned first aspect, and/or the first possible implementation manner, and/or the second possible implementation manner, and/or the third possible implementation manner, and/or the fourth possible implementation manner, and/or the fifth possible implementation manner, and/or the sixth possible implementation manner, and/or the seventh possible implementation manner, in an eighth possible implementation manner, the receiving a first message including CA public key information, includes:

receiving an AS message sent by an access network entity, where the AS message includes the CA public key information.

In combination with the above-mentioned first aspect, and/or the first possible implementation manner, and/or the second possible implementation manner, and/or the third possible implementation manner, and/or the fourth possible implementation manner, and/or the fifth possible implementation manner, and/or the sixth possible implementation manner, and/or the seventh possible implementation manner, and/or the eighth possible implementation manner, in a ninth possible implementation manner, the receiving a first message including CA public key information, includes:

receiving the first message pushed by a network application server in a manner of OTA or OMA-DM at an application layer, where the first message includes the CA public key information.

In combination with the above-mentioned first aspect, and/or the first possible implementation manner, and/or the second possible implementation manner, and/or the third possible implementation manner, and/or the fourth possible implementation manner, and/or the fifth possible implementation manner, and/or the sixth possible implementation manner, and/or the seventh possible implementation manner, and/or the eighth possible implementation manner, and/or the ninth possible implementation manner, in a tenth possible implementation manner, when the CA public key information includes the CA public key, the local CA public key of the UE is updated according to the CA public key;

or, the CA public key information includes the CA public key acquiring information, and when the CA public key acquiring information is a download link of a CA public key, the updating a local CA public key of a UE according to the CA public key acquiring information, includes:

downloading the CA public key through the download link of the CA public key, and updating the local CA public key by using the downloaded CA public key;

or, the CA public key information includes the CA public key acquiring information, and when the CA public key acquiring information is an address for acquiring a CA public key, the updating a local CA public key of a UE according to the CA public key acquiring information, includes:

acquiring the CA public key from the address for acquiring the CA public key, and updating the local CA public key by using the acquired CA public key.

In a second aspect, a method for updating a CA public key is provided, including:

determining CA public key information, where the CA public key information includes a CA public key or CA public key acquiring information; and

sending a first message including the CA public key information to a UE, where the first message is used for updating a local CA public key of the UE.

In combination with the above-mentioned second aspect, in a first possible implementation manner, before the determining CA public key information, the method further includes: receiving a certificate request message in a CMPv2 protocol sent by the UE, where a certificate requested by the certificate request message is a CA public key; and

the sending a first message including the CA public key information to a UE, includes:

sending a certificate response message in the CMPv2 protocol to the UE, where the certificate response message includes the CA public key information.

In combination with the above-mentioned second aspect, and/or the first possible implementation manner, in a second possible implementation manner, the sending a first message including CA public key information to a UE, includes:

sending a CA public key update message to the UE, where the CA public key update message includes the CA public key information.

In combination with the second aspect, and/or the first possible implementation manner, and/or the second possible implementation manner, in a third possible implementation manner, the sending a first message including CA public key information to a UE, includes:

sending the CA public key information to a CBE, such that the CBE broadcasts a PWS warning message through a CBC, where the PWS warning message includes the CA public key information.

In combination with the above-mentioned second aspect, and/or the first possible implementation manner, and/or the second possible implementation manner, and/or the third possible implementation manner, in a fourth possible implementation manner, the determining CA public key information includes:

receiving a PWS warning message broadcasted by a CBE through a CBC, where the PWS warning message includes the CA public key information, and the CA public key information is sent from a CA to the CBE; and

acquiring the CA public key information from the PWS warning message.

In combination with the above-mentioned second aspect, and/or the first possible implementation manner, and/or the second possible implementation manner, and/or the third possible implementation manner, and/or the fourth possible implementation manner, in a fifth possible implementation manner, sending a first message including the CA public key information to a UE, includes:

sending an NAS message to the UE, where the NAS message includes the CA public key information.

In combination with the above-mentioned second aspect, and/or the first possible implementation manner, and/or the second possible implementation manner, and/or the third possible implementation manner, and/or the fourth possible implementation manner, and/or the fifth possible implementation manner, in a sixth possible implementation manner, the sending a first message including the CA public key information to a UE, includes:

sending an AS message to the UE, where the AS message includes the CA public key information.

In combination with the above-mentioned second aspect, and/or the first possible implementation manner, and/or the second possible implementation manner, and/or the third possible implementation manner, and/or the fourth possible implementation manner, and/or the fifth possible implementation manner, and/or the sixth possible implementation manner, in a seventh possible implementation manner, when the PWS warning message includes the CA public key information, the CA public key or the CA public key acquiring information is carried by an SIB, or carried by contents of the PWS warning message, or carried by a security information element in the PWS warning message.

In combination with the above-mentioned second aspect, and/or the first possible implementation manner, and/or the second possible implementation manner, and/or the third possible implementation manner, and/or the fourth possible implementation manner, and/or the fifth possible implementation manner, and/or the sixth possible implementation manner, and/or the seventh possible implementation manner, in an eighth possible implementation manner, when the PWS warning message includes the CA public key information,

the CA public key information further includes a CA public key update instruction, where the CA public key update instruction is carried by a type information element in the PWS warning message, or carried by four idle bytes in the PWS warning message, or carried by a security information element in the PWS warning message, or carried by an SIB.

In combination with the above-mentioned second aspect, and/or the first possible implementation manner, and/or the second possible implementation manner, and/or the third possible implementation manner, and/or the fourth possible implementation manner, and/or the fifth possible implementation manner, and/or the sixth possible implementation manner, and/or the seventh possible implementation manner, and/or the eighth possible implementation manner, in a ninth possible implementation manner, when the PWS warning message includes the CA public key information,

the CA public key information further includes related information of a CA public key, where the related information of the CA public key includes an ID of the CA public key and/or a period of validity of the CA public key, and the related information is carried by a type information element in the PWS warning message, or carried by four idle bytes in the PWS warning message, or carried by a security information element in the PWS warning message, or carried by an SIB, or carried by contents of the PWS warning message.

In combination with the above-mentioned second aspect, and/or the first possible implementation manner, and/or the second possible implementation manner, and/or the third possible implementation manner, and/or the fourth possible implementation manner, and/or the fifth possible implementation manner, and/or the sixth possible implementation manner, and/or the seventh possible implementation manner, and/or the eighth possible implementation manner, and/or the ninth possible implementation manner, in a tenth possible implementation manner, the sending a first message including the CA public key information to a UE, includes:

pushing the first message to the UE in a manner of OTA or OMA-DM at an application layer, where the first message includes the CA public key information.

In a third aspect, an apparatus for updating a CA public key is provided, including:

a first receiving unit, configured to receive a first message including CA public key information, where the CA public key information includes a CA public key or CA public key acquiring information; and

an updating unit, configured to update a local CA public key of a UE according to the CA public key or the CA public key acquiring information.

In combination with the above-mentioned third aspect, in a first possible implementation manner, the apparatus further includes:

a first sending unit, configured to send, before the first message is received, a certificate request message in a CMPv2 protocol to a CA, where a certificate requested by the certificate request message is a CA public key; and

the first receiving unit is configured to receive a certificate response message in the CMPv2 protocol sent by the CA, where the certificate response message includes the CA public key information.

In combination with the above-mentioned third aspect, and/or the first possible implementation manner, in a second possible implementation manner, the first receiving unit is configured to receive a CA public key update message sent by a CA, and the update message includes the CA public key information.

In combination with the above-mentioned third aspect, and/or the first possible implementation manner, and/or the second possible implementation manner, in a third possible implementation manner, the first receiving unit is configured to receive a PWS warning message broadcasted by a CBE through a CBC, where the PWS warning message includes the CA public key information, and the CA public key information is sent from a CA to the CBE.

In combination with the above-mentioned third aspect, and/or the first possible implementation manner, and/or the second possible implementation manner, and/or the third possible implementation manner, in a fourth possible implementation manner, the CA public key or the CA public key acquiring information is carried by an SIB, or carried by contents of the PWS warning message, or carried by a security information element in the PWS warning message.

In combination with the above-mentioned third aspect, and/or the first possible implementation manner, and/or the second possible implementation manner, and/or the third possible implementation manner, and/or the fourth possible implementation manner, in a fifth possible implementation manner, the CA public key information further includes a CA public key update instruction, and the CA public key update instruction is carried by a type information element in the PWS warning message, or carried by four idle bytes in the PWS warning message, or carried by a security information element in the PWS warning message, or carried by an SIB.

In combination with the above-mentioned third aspect, and/or the first possible implementation manner, and/or the second possible implementation manner, and/or the third possible implementation manner, and/or the fourth possible implementation manner, and/or the fifth possible implementation manner, in a sixth possible implementation manner, the CA public key information further includes related information of a CA public key, and the related information of the CA public key includes an ID of the CA public key and/or a period of validity of the CA public key, where the related information of the CA public key is carried by a type information element in the PWS warning message, or carried by four idle bytes in the PWS warning message, or carried by a security information element in the PWS warning message, or carried by an SIB, or carried by contents of the PWS warning message.

In combination with the above-mentioned third aspect, and/or the first possible implementation manner, and/or the second possible implementation manner, and/or the third possible implementation manner, and/or the fourth possible implementation manner, and/or the fifth possible implementation manner, and/or the sixth possible implementation manner, in a seventh possible implementation manner, the first receiving unit is configured to receive an NAS message sent by a core network entity, and the NAS message includes the CA public key information.

In combination with the above-mentioned third aspect, and/or the first possible implementation manner, and/or the second possible implementation manner, and/or the third possible implementation manner, and/or the fourth possible implementation manner, and/or the fifth possible implementation manner, and/or the sixth possible implementation manner, and/or the seventh possible implementation manner, in an eighth possible implementation manner, the first receiving unit is configured to receive an AS message sent by an access network entity, and the AS message includes the CA public key information.

In combination with the above-mentioned third aspect, and/or the first possible implementation manner, and/or the second possible implementation manner, and/or the third possible implementation manner, and/or the fourth possible implementation manner, and/or the fifth possible implementation manner, and/or the sixth possible implementation manner, and/or the seventh possible implementation manner, and/or the eighth possible implementation manner, in a ninth possible implementation manner, the first receiving unit is configured to receive the first message pushed by a network application server in a manner of OTA or OMA-DM at an application layer, and the first message includes the CA public key information.

In combination with the above-mentioned third aspect, and/or the first possible implementation manner, and/or the second possible implementation manner, and/or the third possible implementation manner, and/or the fourth possible implementation manner, and/or the fifth possible implementation manner, and/or the sixth possible implementation manner, and/or the seventh possible implementation manner, and/or the eighth possible implementation manner, and/or the ninth possible implementation manner, in a tenth possible implementation manner, the updating unit is configured to update, when the CA public key information includes the CA public key, the local CA public key of the UE according to the CA public key;

or, the CA public key information includes the CA public key acquiring information, and when the CA public key acquiring information is a download link of a CA public key, the updating a local CA public key of a UE according to the CA public key acquiring information, includes:

downloading the CA public key through the download link of the CA public key, and updating the local CA public key by using the downloaded CA public key;

or, the CA public key information includes the CA public key acquiring information, and when the CA public key acquiring information is an address for acquiring a CA public key, the updating a local CA public key of a UE according to the CA public key acquiring information, includes:

acquiring the CA public key from the address for acquiring the CA public key, and updating the local CA public key by using the acquired CA public key.

In a fourth aspect, an apparatus for updating a CA public key is provided, including:

a determining unit, configured to determine CA public key information, where the CA public key information includes a CA public key or CA public key acquiring information; and

a second sending unit, configured to send a first message including the CA public key information determined by the determining unit to a UE, where the first message is used for updating a local CA public key of the UE.

In combination with the above-mentioned fourth aspect, in a first possible implementation manner, the apparatus further includes:

a second receiving unit, configured to receive, before the determining unit determines the CA public key information, a certificate request message in a CMPv2 protocol sent by the UE, where a certificate requested by the certificate request message is a CA public key; and

the second sending unit is configured to send a certificate response message in the CMPv2 protocol to the UE, and the certificate response message includes the CA public key information.

In combination with the above-mentioned fourth aspect, and/or the first possible implementation manner, in a second possible implementation manner, the second sending unit is configured to send a CA public key update message to the UE, and the CA public key update message includes the CA public key information.

In combination with the above-mentioned fourth aspect, and/or the first possible implementation manner, and/or the second possible implementation manner, in a third possible implementation manner, the second sending unit is configured to send the CA public key information to a CBE, such that the CBE broadcasts a PWS warning message through a CBC, where the PWS warning message includes the CA public key information.

In combination with the above-mentioned fourth aspect, and/or the first possible implementation manner, and/or the second possible implementation manner, and/or the third possible implementation manner, in a fourth possible implementation manner, the determining unit includes:

the determining unit includes:

a first receiving subunit, configured to receive a PWS warning message broadcast by a CBE through a CBC, where the PWS warning message includes the CA public key information, and the CA public key information is sent from a CA to the CBE; and

a first acquiring subunit, configured to acquire the CA public key information from the PWS warning message.

In combination with the above-mentioned fourth aspect, and/or the first possible implementation manner, and/or the second possible implementation manner, and/or the third possible implementation manner, and/or the fourth possible implementation manner, in a fifth possible implementation manner, the second sending unit is configured to send an NAS message to the UE, and the NAS message includes the CA public key information.

In combination with the above-mentioned fourth aspect, and/or the first possible implementation manner, and/or the second possible implementation manner, and/or the third possible implementation manner, and/or the fourth possible implementation manner, and/or the fifth possible implementation manner, in a sixth possible implementation manner, the second sending unit is configured to send an AS message to the UE, and the AS message includes the CA public key information.

In combination with the above-mentioned fourth aspect, and/or the first possible implementation manner, and/or the second possible implementation manner, and/or the third possible implementation manner, and/or the fourth possible implementation manner, and/or the fifth possible implementation manner, and/or the sixth possible implementation manner, in a seventh possible implementation manner, when the PWS warning message includes the CA public key information, the CA public key or the CA public key acquiring information is carried by an SIB, or carried by contents of the PWS warning message, or carried by a security information element in the PWS warning message.

In combination with the above-mentioned fourth aspect, and/or the first possible implementation manner, and/or the second possible implementation manner, and/or the third possible implementation manner, and/or the fourth possible implementation manner, and/or the fifth possible implementation manner, and/or the sixth possible implementation manner, and/or the seventh possible implementation manner, in an eighth possible implementation manner, when the PWS warning message includes the CA public key information,

the CA public key information further includes a CA public key update instruction, where the CA public key update instruction is carried by a type information element in the PWS warning message, or carried by four idle bytes in the PWS warning message, or carried by a security information element in the PWS warning message, or carried by an SIB.

In combination with the above-mentioned fourth aspect, and/or the first possible implementation manner, and/or the second possible implementation manner, and/or the third possible implementation manner, and/or the fourth possible implementation manner, and/or the fifth possible implementation manner, and/or the sixth possible implementation manner, and/or the seventh possible implementation manner, and/or the eighth possible implementation manner, in a ninth possible implementation manner, when the PWS warning message includes the CA public key information,

the CA public key information further includes related information of a CA public key, where the related information of the CA public key includes an ID of the CA public key and/or a period of validity of the CA public key, and the related information is carried by a type information element in the PWS warning message, or carried by four idle bytes in the PWS warning message, or carried by a security information element in the PWS warning message, or carried by an SIB, or carried by contents of the PWS warning message.

In combination with the above-mentioned fourth aspect, and/or the first possible implementation manner, and/or the second possible implementation manner, and/or the third possible implementation manner, and/or the fourth possible implementation manner, and/or the fifth possible implementation manner, and/or the sixth possible implementation manner, and/or the seventh possible implementation manner, and/or the eighth possible implementation manner, and/or the ninth possible implementation manner, in a tenth possible implementation manner, the second sending unit is configured to push the first message to the UE in a manner of OTA or OMA-DM at an application layer, and the first message includes the CA public key information.

In a fifth aspect, a UE is provided, including:

a first wireless transceiver, configured to receive a first message including CA public key information, where the CA public key information includes a CA public key or CA public key acquiring information; and

a first data processor, configured to update a local CA public key of the UE according to the CA public key or the CA public key acquiring information.

In combination with the above-mentioned fifth aspect, in a first possible implementation manner, the first wireless transceiver is further configured to send, before the first message is received, a certificate request message in a CMPv2 protocol to a CA, where a certificate requested by the certificate request message is a CA public key; and

the first wireless transceiver is further configured to receive a certificate response message in the CMPv2 protocol sent by the CA, where the certificate response message includes the CA public key information.

In combination with the above-mentioned fifth aspect, and/or the first possible implementation manner, in a second possible implementation manner, the first wireless transceiver is configured to receive a CA public key update message sent by a CA, and the update message includes the CA public key information.

In combination with the above-mentioned fifth aspect, and/or the first possible implementation manner, and/or the second possible implementation manner, in a third possible implementation manner, the first wireless transceiver is configured to receive a PWS warning message broadcasted by a CBE through a CBC, where the PWS warning message includes the CA public key information, and the CA public key information is sent from a CA to the CBE.

In combination with the above-mentioned fifth aspect, and/or the first possible implementation manner, and/or the second possible implementation manner, and/or the third possible implementation manner, in a fourth possible implementation manner, the CA public key or the CA public key acquiring information is carried by an SIB, or carried by contents of the PWS warning message, or carried by a security information element in the PWS warning message.

In combination with the above-mentioned fifth aspect, and/or the first possible implementation manner, and/or the second possible implementation manner, and/or the third possible implementation manner, and/or the fourth possible implementation manner, in a fifth possible implementation manner, the CA public key information further includes a CA public key update instruction, and the CA public key update instruction is carried by a type information element in the PWS warning message, or carried by four idle bytes in the PWS warning message, or carried by a security information element in the PWS warning message, or carried by an SIB.

In combination with the above-mentioned fifth aspect, and/or the first possible implementation manner, and/or the second possible implementation manner, and/or the third possible implementation manner, and/or the fourth possible implementation manner, and/or the fifth possible implementation manner, in a sixth possible implementation manner, the CA public key information further includes related information of a CA public key, and the related information of the CA public key includes an ID of the CA public key and/or a period of validity of the CA public key, where the related information of the CA public key is carried by a type information element in the PWS warning message, or carried by four idle bytes in the PWS warning message, or carried by a security information element in the PWS warning message, or carried by an SIB, or carried by contents of the PWS warning message.

In combination with the above-mentioned fifth aspect, and/or the first possible implementation manner, and/or the second possible implementation manner, and/or the third possible implementation manner, and/or the fourth possible implementation manner, and/or the fifth possible implementation manner, and/or the sixth possible implementation manner, in a seventh possible implementation manner, the first wireless transceiver is configured to receive an NAS message sent by a core network entity, and the NAS message includes the CA public key information.

In combination with the above-mentioned fifth aspect, and/or the first possible implementation manner, and/or the second possible implementation manner, and/or the third possible implementation manner, and/or the fourth possible implementation manner, and/or the fifth possible implementation manner, and/or the sixth possible implementation manner, and/or the seventh possible implementation manner, in an eighth possible implementation manner, the first wireless transceiver is configured to receive an AS message sent by an access network entity, and the AS message includes the CA public key information.

In combination with the above-mentioned fifth aspect, and/or the first possible implementation manner, and/or the second possible implementation manner, and/or the third possible implementation manner, and/or the fourth possible implementation manner, and/or the fifth possible implementation manner, and/or the sixth possible implementation manner, and/or the seventh possible implementation manner, and/or the eighth possible implementation manner, in a ninth possible implementation manner, the first wireless transceiver is configured to receive the first message pushed by a network application server in a manner of OTA or OMA-DM at an application layer, and the first message includes the CA public key information.

In combination with the above-mentioned fifth aspect, and/or the first possible implementation manner, and/or the second possible implementation manner, and/or the third possible implementation manner, and/or the fourth possible implementation manner, and/or the fifth possible implementation manner, and/or the sixth possible implementation manner, and/or the seventh possible implementation manner, and/or the eighth possible implementation manner, and/or the ninth possible implementation manner, in a tenth possible implementation manner, the first data processor is configured to update, when the CA public key information includes the CA public key, the local CA public key of the UE according to the CA public key;

or, the CA public key information includes the CA public key acquiring information, and when the CA public key acquiring information is a download link of a CA public key, the updating a local CA public key of a UE according to the CA public key acquiring information, includes:

downloading the CA public key through the download link of the CA public key, and updating the local CA public key by using the downloaded CA public key;

or, the CA public key information includes the CA public key acquiring information, and when the CA public key acquiring information is an address for acquiring a CA public key, the updating a local CA public key of a UE according to the CA public key acquiring information, includes:

acquiring the CA public key from the address for acquiring the CA public key, and updating the local CA public key by using the acquired CA public key.

In a sixth aspect, a CA is provided, including:

a second data processor, configured to determine CA public key information, where the CA public key information includes a CA public key or CA public key acquiring information; and

a second wireless transceiver, configured to send a first message including the CA public key information determined by the second data processor to a UE, where the first message is used for updating a local CA public key of the UE.

In combination with the above-mentioned sixth aspect, in a first possible implementation manner,

the second wireless transceiver is further configured to receive, before the second data processor determines the CA public key information, a certificate request message in a CMPv2 protocol sent by the UE, where a certificate requested by the certificate request message is a CA public key; and

the second wireless transceiver is configured to send a certificate response message in the CMPv2 protocol to the UE, where the certificate response message includes the CA public key information.

In combination with the above-mentioned sixth aspect, and/or the first possible implementation manner, in a second possible implementation manner, the second wireless transceiver is configured to send a CA public key update message to the UE, and the CA public key update message includes the CA public key information.

In combination with the above-mentioned sixth aspect, and/or the first possible implementation manner, and/or the second possible implementation manner, in a third possible implementation manner, the second wireless transceiver is configured to send the CA public key information to a CBE, such that the CBE broadcasts a PWS warning message through a CBC, where the PWS warning message includes the CA public key information.

In a seventh aspect, a core network entity is provided, including:

a third data processor, configured to determine CA public key information, where the CA public key information includes a CA public key or CA public key acquiring information; and

a third wireless transceiver, configured to send a first message including the CA public key information determined by the third data processor to a UE, where the first message is used for updating a local CA public key of the UE.

In combination with the above-mentioned seventh aspect, in a first possible implementation manner, the third wireless transceiver is further configured to receive a PWS warning message broadcasted by a CBE through a CBC, where the PWS warning message includes the CA public key information, and the CA public key information is sent from a CA to the CBE; and

the third data processor is configured to acquire the CA public key information from the PWS warning message.

In combination with the above-mentioned seventh aspect, and/or the first possible implementation manner, in a second possible implementation manner, the third wireless transceiver is configured to send an NAS message to the UE, and the NAS message includes the CA public key information.

In an eighth aspect, an access network entity is provided, including:

a fourth data processor, configured to determine CA public key information, where the CA public key information includes a CA public key or CA public key acquiring information; and

a fourth wireless transceiver, configured to send a first message including the CA public key information determined by the fourth data processor to a UE, where the first message is used for updating a local CA public key of the UE.

In combination with the above-mentioned eighth aspect, in a first possible implementation manner, the fourth wireless transceiver is further configured to receive a PWS warning message broadcasted by a CBE through a CBC, where the PWS warning message includes the CA public key information, and the CA public key information is sent from a CA to the CBE; and

the fourth data processor is configured to acquire the CA public key information from the PWS warning message.

In combination with the above-mentioned eighth aspect, and/or the first possible implementation manner, in a second possible implementation manner, the fourth wireless transceiver is configured to send an AS message to the UE, and the AS message includes the CA public key information.

In a ninth aspect, a network application server is provided, including:

a fifth data processor, configured to determine CA public key information, where the CA public key information includes a CA public key or CA public key acquiring information; and

a fifth wireless transceiver, configured to send a first message including the CA public key information determined by the fifth data processor to a UE, where the first message is used for updating a local CA public key of the UE.

In combination with the above-mentioned ninth aspect, in a first possible implementation manner, the fifth wireless transceiver is configured to push the first message to the UE in a manner of OTA or OMA-DM at an application layer, and the first message includes the CA public key information.

In the embodiments of the present invention, by receiving the first message including the CA public key information, and updating the CA public key in the UE according to the CA public key or the CA public key acquiring information included in the first message, the CA public key configured in the UE is updated.

### BRIEF DESCRIPTION OF DRAWINGS

To illustrate technical solutions in the embodiments of the present invention or in the prior art more clearly, a brief introduction on the accompanying drawings which are needed in the description of the embodiments or the prior art is given below. Apparently, the accompanying drawings in the description below are merely some of the embodiments of the present invention, based on which other drawings may be obtained by those of ordinary skills in the art without any creative effort.

FIG. 1 is a schematic diagram of a first embodiment of a method for updating a CA public key in the embodiments of the present invention;

FIG. 2 is a schematic diagram of a second embodiment of the method for updating a CA public key in the embodiments of the present invention;

FIG. 3 is a schematic diagram of a third embodiment of the method for updating the CA public key in the embodiments of the present invention;

FIG. 3A is a schematic diagram of a structure of a certificate;

FIG. 4 is a schematic diagram of a fourth embodiment of the method for updating a CA public key in the embodiments of the present invention;

FIG. 5 is a schematic diagram of a first embodiment of the method for updating a CA public key in the embodiments of the present invention;

FIG. 5A is a flowchart of broadcasting a PWS warning message by a CBE through a CBC;

FIG. 6 is a schematic diagram of a sixth embodiment of the method for updating a CA public key in the embodiments of the present invention;

FIG. 6A is a flowchart of transmitting an NAS SMC message between a UE and an MME;

FIG. 7 is a schematic diagram of a seventh embodiment of the method for updating a CA public key in the embodiments of the present invention;

FIG. 7A is a flowchart of transmitting an AS SMC message between a UE and an eNB;

FIG. 8 is a schematic diagram of an eighth embodiment of the method for updating a CA public key in the embodiments of the present invention;

FIG. 8A is a flowchart of transmitting CA public key information between a UE and a network application server;

FIG. 9 is a schematic diagram of a first embodiment of an apparatus for updating a CA public key in the present invention;

FIG. 9A is a schematic diagram of a second embodiment of the apparatus for updating a CA public key in the present invention;

FIG. 10 is a schematic diagram of a third embodiment of the apparatus for updating a CA public key in the present invention;

FIG. 10A is a schematic diagram of a fourth embodiment of an apparatus for updating a CA public key in the present invention;

FIG. 11 is a schematic diagram of a structure of a UE in an embodiment of the present invention;

FIG. 12 is a schematic diagram of a structure of a CA in an embodiment of the present invention;

FIG. 13 is a schematic diagram of a structure of a core network entity in an embodiment of the present invention;

FIG. 14 is a schematic diagram of a structure of an access network entity in an embodiment of the present invention; and

FIG. 15 is a schematic diagram of a structure of a network application server in an embodiment of the present invention.

### DESCRIPTION OF EMBODIMENTS

In order to enable those skilled in the art to better understand the technical solutions in the embodiments of the present invention, and to make the above-mentioned purposes, characteristics and advantages in the embodiments of the present invention more obvious and easy to be understood, the technical solutions in the embodiments of the present invention will be further described in detail below in combination with accompanying drawings.

In the embodiments of the present invention, the CA public key information includes a CA public key or CA public key acquiring information. Preferably, the CA public key information may further include an update instruction for a CA public key, and the update instruction for a CA public key is used for instructing a UE to update the CA public key. Preferably, the CA public key information may further include related information of a CA public key, and the related information may include an ID of the CA public key, a period of validity of the CA public key and/or the like.

FIG. 1 is a schematic diagram of a first embodiment of a method for updating a CA public key in the embodiments of the present invention. The method is applicable to a UE, and the method includes the following steps.

Step 101: a first message including CA public key information is received, where the CA public key information at least includes a CA public key or CA public key acquiring information.

Preferably, before the receiving a first message, the method may further include: sending a certificate request message in a certificate management protocol (CMP) v2 protocol to a CA, where a certificate requested by the certificate request message is a CA public key;

and correspondingly, the receiving a first message including CA public key information may include: receiving a certificate response message in the CMPv2 protocol sent by the CA, where the certificate response message includes the CA public key information.

Preferably, the receiving a first message including CA public key information may include: receiving a CA public key update message sent by the CA, where the update message includes the CA public key information.

Preferably, the receiving a first message including CA public key information may include: receiving a PWS warning message broadcasted by a CBE through a CBC, where the PWS warning message includes the CA public key information, and the CA public key information is sent from a CA to the CBE.

Preferably, when the CA public key information is included in the PWS warning message,

the CA public key or the CA public key acquiring information may be carried by a system information block (SIB), or carried by contents of the PWS warning message, or carried by a security information element;

when the CA public key information includes an CA public key update instruction, the CA public key update instruction may be carried by a type information element in the PWS warning message, or carried by four idle bytes in the PWS warning message, or carried by a security information element in the PWS warning message, or carried by an SIB; and

when the CA public key information includes related information of a CA public key, the related information of the CA public key may be carried by a type information element in the PWS warning message, or carried by four idle bytes in the PWS warning message, or carried by a security information element in the PWS warning message, or carried by an SIB, or carried by contents of the PWS warning message.

Preferably, the receiving a first message including CA public key information may include: receiving an NAS message sent by a core network entity, where the NAS message includes the CA public key information.

The core network entity is different in different network systems. For example, in a 3GPP long term evolution (LTE) system, the core network entity may be a mobility management entity (MME); in a universal mobile telecommunications system (UMTS), the core network entity may be a service GPRS support node (SGSN); and in a global system for mobile communications (GSM), the core network entity may be a mobile switching center (MSC).

Preferably, the receiving a first message including CA public key information may include: receiving an AS message sent by an access network entity, where the AS message includes the CA public key information.

The core network entity is different in different network systems. For example, in an LTE system, the access network entity may be an evolved base station (eNB); in a GSM system, the access network entity may be a base station subsystem (BSS), and the BSS mainly includes a base transceiver station (BTS) and a base station controller (BSC); and in a UMTS system, the access network entity may be a base station (Node B) or a radio network controller (RNC).

Preferably, the receiving a first message including CA public key information may include: receiving a first message sent by a network application server in a manner of over the air (OTA) or an open mobile alliance device management (OMA-DM) at an application layer, where the first message includes the CA public key information.

Step 102, a local CA public key of the UE is updated according to the CA public key or the CA public key acquiring information.

The CA public key acquiring information may be a download link of a CA public key, an address for acquiring a CA public key or the like.

When the first message includes the CA public key, the updating a local CA public key of the UE according to the CA public key may include: updating the local CA public key by using the CA public key included in the first message.

When the first message includes the CA public key acquiring information, and when the CA public key acquiring information is a download link of a CA public key, the updating a local CA public key according to the CA public key acquiring information may include: downloading the CA public key through the download link of the CA public key, and updating the local CA public key by using the downloaded CA public key.

When the first message includes the CA public key acquiring information, and when the CA public key acquiring information is an address of a CA public key, the updating a local CA public key may include: acquiring the CA public key from the address for acquiring the CA public key, and updating the local CA public key by using the acquired CA public key.

Preferably, when the CA public key information further includes related information of a CA public key, the step 102 may correspondingly further include the following step: updating, by the UE, local corresponding information of the UE according to the related information of the CA public key carried in the first message, such as, for example, updating a period of validity of the CA public key, an ID of the CA public key and/or the like, which will not be repeated redundantly herein.

Preferably, between step 101 and step 102, the method may further include the following step: determining whether the first message carries a CA public key update instruction. When the UE makes the determination, the CA public key update instruction needs to be carried in the CA public key information, such that after the first message received, the UE may determine that the first message carries the CA public key update instruction, and further update the CA public key in step 102. If the CA public key information does not carry the CA public key update instruction, the UE determines that the first message does not carry the CA public key update instruction, and does not perform the update of the CA public key, namely not performing step 102.

In the update method as shown in FIG. 1, the first message including the CA public key information is received, and the local CA public key of the UE is updated according to the CA public key or the CA public key acquiring information included in the first message, thereby realizing update of the CA public key in the UE.

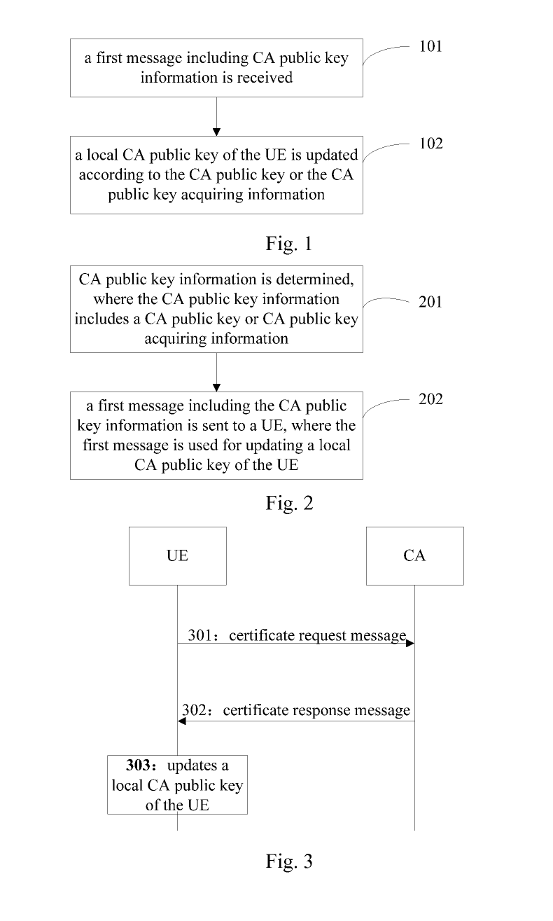

Referring to FIG. 2, a second embodiment of the method for updating a CA public key in the embodiments of the present invention is schematically depicted. The method may be applicable to an eNB, an MME, a CA, a network application server or the like, and the method includes the following steps.

Step 201: CA public key information is determined, where the CA public key information includes a CA public key or CA public key acquiring information.

The CA public key information may further include a CA public key update instruction, related information of a CA public key such as, for example, an ID, a period of validity and/or the like.

When the present embodiment is applied to a CA, the CA public key may be generated by the CA, and a specific generation method is not limited herein; or the CA public key may be configured to the CA by an upper layer entity of the CA, which is not limited herein neither.

When the present embodiment is applied to an access network entity or a core network entity,

the CA public key information may be pre-stored in an access network entity or in an core network entity, and an implementation of the present step may include: reading, by the access network entity or the core network entity, the CA public key information from a corresponding storage address;

or, the CA public key information may be included in a PWS warning message, where the CA public key information is sent from a CA to a CBE, and the CBE broadcasts the PWS warning message to the access network entity or the core network entity through a CBC. In this case, the present step may include: receiving, by the access network entity or the core network entity, the PWS warning message broadcasted by the CBE through the CBC, where the PWS warning message includes the CA public key information, the CA public key information is sent from the CA to the CBE, and the CA public key information is acquired from the PWS warning message.

When the present embodiment is applied to a network application server,

the CA public key information may be pre-stored in the network application server, and an implementation of the present step may include: acquiring, by the network application server, the CA public key information from a corresponding storage address;

or, an implementation of the present step may include: acquiring, by the network application server, the CA public key information from a CA through a secure connection between the CA and the network application server.

Step 202, a first message including the CA public key information is sent to a UE, where the first message is used for updating a local CA public key of the UE.

When the present embodiment is applied to a CA,

preferably, before step 201, the method may further include: receiving a certificate request message in a CMPv2 protocol sent by the UE, where a certificate requested by the certificate request message is a CA public key;

and correspondingly, the sending a first message including the CA public key information to a UE may include: sending a certificate response message in the CMPv2 protocol to the UE, where the certificate response message includes the CA public key information.

Preferably, the sending a first message including the CA public key information to a UE may include: sending a CA public key update message to the UE, where the CA public key update message includes the CA public key information.

Preferably, the sending a first message including the CA public key information to a UE may include: broadcasting a PWS warning message through a CBE, where the PWS warning message includes the CA public key information.

When the present embodiment is applied to a core network entity, the sending a first message including the CA public key information to a UE may include: sending a non access stratum (NAS) message to the UE, where the NAS message includes the CA public key information.

When the present embodiment is applied to an access network entity, the sending a first message including the CA public key information to a UE may include: sending an access stratum (AS) message to the UE, where the AS message includes the CA public key information.

When the present embodiment is applied to a network application server, the sending a first message including the CA public key information to a UE may include: sending a message to the UE in a manner of OTA or OMA-DM at an application layer, where the message includes the CA public key information.

In the update method as shown in FIG. 2, the CA public key information including the CA public key or the CA public key acquiring information is determined, and the first message including the CA public key information is sent to the UE, thereby realizing sending the CA public key or the CA public key acquiring information to the UE. The method may be cooperated with the update method as shown in FIG. 1, so as to realize update of the CA public key in the UE.

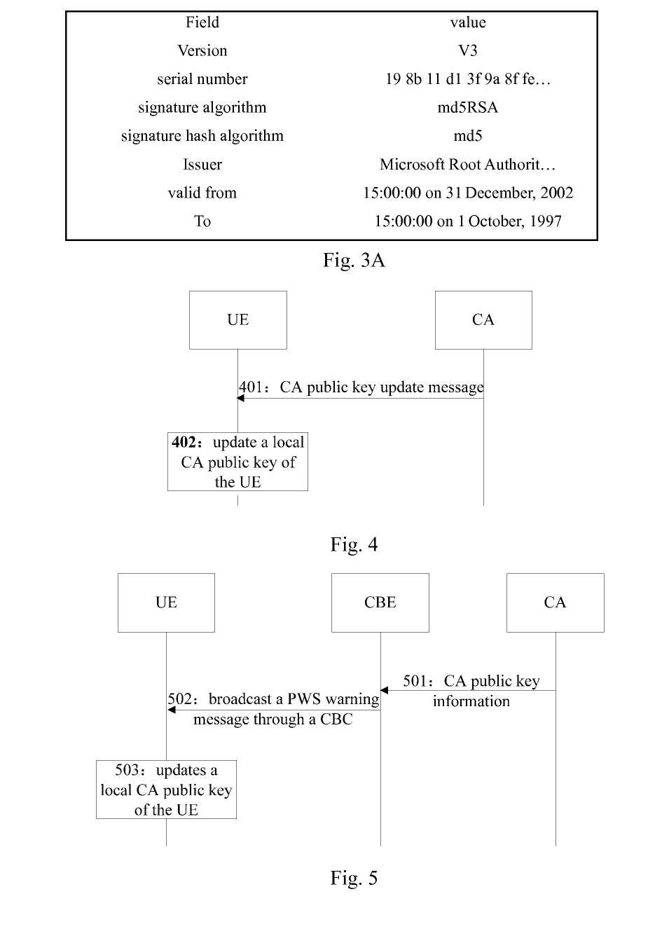

Referring to FIG. 3, a third embodiment of the method for updating a CA public key in the embodiments of the present invention is schematically depicted. The method includes the following steps.

Step 301: a UE sends a certificate request message in a CMPv2 protocol to a CA, where a certificate requested by the certificate request message is a CA public key.

In general, the CA public key is stored in the UE in a form of an entire certificate. As shown in FIG. 3A, the certificate is marked with information of the CA public key in detail, such as a version number, a serial number, a signature algorithm, an issuer, a period of validity and/or the like. Therefore, the UE may identify whether the CA public key is about to exceed the period of validity through the information stored in the certificate, and request the CA to update the CA public key before the CA public key exceeds the period of validity.

Step 302: the CA sends a certificate response message in the CMPv2 protocol to the UE, where the certificate response message includes CA public key information.

In version 2 of CMP defined in an IETF RFC4210 protocol, the certificate request message (Certificate Request) and corresponding certificate response message (Certificate Response) are defined.

In the present embodiment of the present invention, how the UE uses the certificate request message to request the CA public key and how the CA uses the certificate response message to send the CA public key information to the UE are not limited herein.

Step 303: the UE receives the certificate response message in the CMPv2 protocol sent by the CA, and updates a local CA public key of the UE according to a CA public key or CA public key acquiring information included in the certificate response message.

Descriptions in step 102 may be referred to for how the UE updates the local CA public key according to the CA public key or the CA public key acquiring information, which will not be repeated redundantly herein.

In the update method as shown in FIG. 3, the UE actively requests the CA public key from the CA through the certificate request message, the CA correspondingly sends the CA public key information through the certificate response message, and the UE updates the local CA public key of the UE according to the CA public key or the CA public key acquiring information in the CA public key information, thereby realizing update of the CA public key in the UE.

Referring to FIG. 4, a fourth embodiment of the method for updating a CA public key in the embodiments of the present invention is schematically depicted. The method includes the following steps.

Step 401: a CA sends a CA public key update message to a UE, where the CA public key update message includes CA public key information.

The CA public key update message is a CA Key Update Announcement Content message.

When the CA public key is due, or when a CA public key in the CA is updated, the CA may actively send the CA public key update message to the UE, so as to send the CA public key and other related CA public key information to the UE for update.

Step 402: the UE receives the CA public key update message, and updates a local CA public key according to a CA public key or CA public key information included in the update message.

Descriptions in step 102 may be referred to for how the UE updates the local CA public key according to the CA public key or the CA public key acquiring information, which will not be repeated redundantly herein.

In the update method as shown in FIG. 4, the UE does not need to request the CA public key, the CA actively sends the CA public key update message to the UE instead, and the UE updates the local CA public key according to the CA public key or the CA public key acquiring information included in the update message, thereby realizing update of the CA public key in the UE.

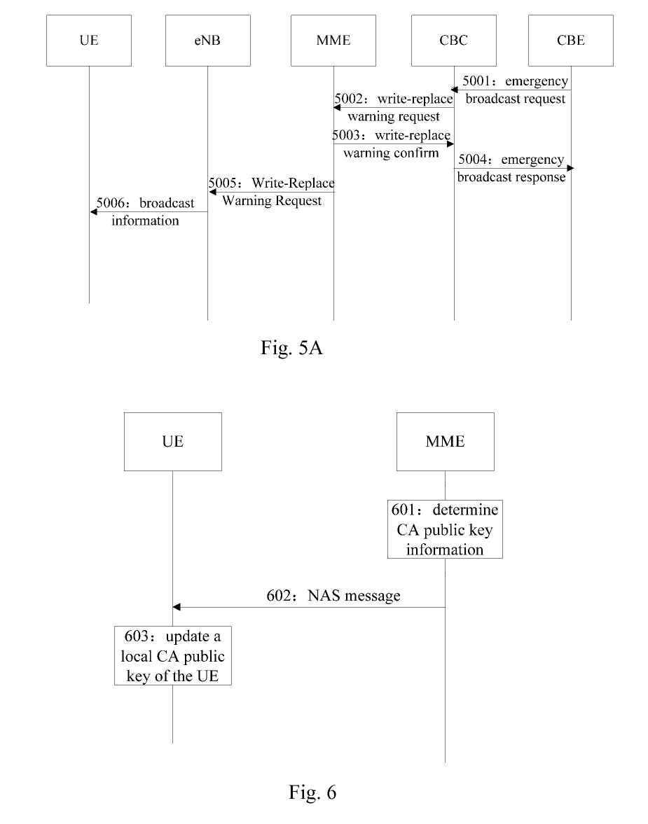

Referring to FIG. 5, a fifth embodiment of the method for updating a CA public key in the embodiments of the present invention is schematically depicted. The method includes the following steps.

Step 501: a CA sends CA public key information to a CBE.

Step 502: the CBE broadcasts a PWS warning message through a CBC, where the PWS warning message includes the CA public key information.

A process of broadcasting a PWS warning message by a CBE through a CBC in the prior art may be referred to for an implementation of the present step, and a difference only lies in that the broadcasted PWS warning message carries the CA public key information.

An implementation process of broadcasting the PWS warning message by the CBE through the CBC will be simply introduced below through FIG. 5A.

Step 5001: the CBE sends an emergency broadcast request (Emergency Broadcast Request) to the CBC, where the request carries CA public key information.

Step 5002: the CBC sends a write-replace warning request (Write-Replace Warning Request) to an MME, where the request carries the CA public key information.

Step 5003: the MME sends a write-replace warning confirm (Write-Replace Warning Confirm) to the CBC.

Step 5004: the CBC sends an emergency broadcast response (Emergency Broadcast Response) to the CBE.

Step 5005: the MME sends a Write-Replace Warning Request to an eNB, where the request carries the CA public key information.

Step 5006: the eNB sends broadcast information (Broadcast Information), where the broadcast information includes the CA public key information.

Therefore, the UE receives the broadcast information sent by the eNB and acquires the CA public key information.

The emergency broadcast request, the write-replace warning request and the broadcast information are collectively referred to as a PWS warning message.

Preferably, the CA public key or the CA public key acquiring information may be carried by an SIB, or carried by contents of the PWS warning message, or carried by a security information element.

When the CA public key or the CA public key acquiring information is carried by the SIB, the CA public key or the CA public key acquiring information may specifically be carried by an SIB10 or an SIB11.

When the CA public key information includes a CA public key update instruction, the CA public key update instruction may be carried by a type information element in the PWS warning message, or carried by four idle bytes in the PWS warning message, or carried by a security information element in the PWS warning message, or carried by an SIB.

When the CA public key information includes related information of the CA public key, the related information may be carried by a type information element in the PWS warning message, or carried by four idle bytes in the PWS warning message, or carried by a security information element in the PWS warning message, or carried by an SIB, or carried by contents of the PWS warning message.

Example 1: if an SIB10 carries the CA public key, and the CA public key is too long, the CA public key may be carried in SIB 11 or in a newly defined SIB. Specifically, the following method may be adopted for implementation:

| SystemInformationBlockType10 ::= | | SEQUENCE { | |
|---|---|---|---|
| | messageIdentifier | BIT STRING (SIZE (16)), | |
| | serialNumber | BIT STRING (SIZE (16)), | |
| | warningType | OCTET STRING (SIZE (2)), | |
| | CA′s public key update | OCTET STRING (SIZE (x)) OPTIONAL, - Need OP | |
| | CA′s public key ID | OCTET STRING (SIZE (y)) OPTIONAL, - Need OP | |
| | CA′s public key validity | OCTET STRING (SIZE (z)) OPTIONAL, - Need OP | |
| | CA′s public key | OCTET STRING (SIZE (z)) OPTIONAL, - Need OP | |
| | warningSecurityInfo | OCTET STRING (SIZE (50)) OPTIONAL, - Need OP | |
| | ..., | | |
| | lateNonCriticalExtension | OCTET STRING OPTIONAL | -- Need OP |

}

Example 2: when the CA public key or the CA public key acquiring information is carried by an SIB11, the following program may be adopted for implementation:

| SystemInformationBlockType11 ::= | | SEQUENCE { | |
|---|---|---|---|
| | messageIdentifier | BIT STRING (SIZE (16)), | |
| | serialNumber | BIT STRING (SIZE (16)), | |
| | warningMessageSegmentType | ENUMERATED {notLastSegment, lastSegment}, | |
| | warningMessageSegmentNumber | | INTEGER {0..63}, |

| warningMessageSegment | OCTET STRING, | |
|---|---|---|
| dataCodingScheme | OCTET STRING (SIZE (1)) OPTIONAL, -- Cond Segment1 | |
| ..., | | |
| lateNonCriticalExtension | OCTET STRING | OPTIONAL -- Need OP |

}

Example 3: the CA public key update instruction may be carried by one byte in a type information element. Specifically, one RES bit 0000101 may be selected to carry the CA public key update instruction, and Table 1 may be referred to for a specific implementation.

TABLE 1

| Warning type Value | Warning type |
|---|---|
| 0000000 | Earthquake |
| 0000001 | Tsunami |
| 0000010 | Earthquake and Tsunami |
| 0000011 | Test |
| 0000100 | Others |
| 0000101 | CA’ Public: key Updata |
| 0000110-1111111 | Reserved for future use |

Example 4: the CA public key update instruction may also be carried by one byte of four idle bytes in the PWS warning message, and the related information of the CA public key may be carried by another byte of the four idle bytes, as shown in Table 2:

TABLE 2

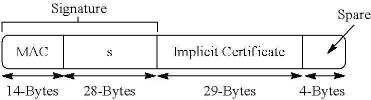

Example 5: when the CA public key information is carried by the security information element, a specific carrying method is as shown in Table 3. Where when the CA public key is carried by the security information element, the security information element generally needs to be expanded.

TABLE 3

| | | | | | | | |
|---|---|---|---|---|---|---|---|
| 8 | 7 | 6 | 5 | 4 | 3 | 2 | 1 |

| | | |
|---|---|---|
| | Year | octet 1 |
| | Month | octet 2 |
| | Day | octet 3 |
| | Hour | octet 4 |
| | Minute | octet 5 |
| | Second | octet 6 |
| | Time zone | octet 7 |
| Update | CA′s public key ID | Octet8 |
| | CA′s pubic key validity | Octet9~n |
| | CA′s public key | Octet(n+1)~p |
| | Digital Signature | octet P+1~ |
| | | octet m |

Example 6: when the period of validity of the CA public key is carried in the SIB10, the following method may be adopted for implementation:

| SystemInformationBlockType10 ::= | | SEQUENCE { | |
|---|---|---|---|
| | messageIdentifier | BIT STRING (SIZE (16)), | |
| | serialNumber | BIT STRING (SIZE (16)), | |
| | warning Type | OCTET STRING (SIZE (2)), | |
| | CA′ public key validity | OCTET STRING (SIZE (x)) OPTIONAL, | - Need OP |
| | warningSecurityInfo | OCTET STRING (SIZE (50)) OPTIONAL, | - Need OP |

| ..., | | |
|---|---|---|
| lateNonCriticalExtension | OCTET STRING | OPTIONAL -- Need OP |

}

In an embodiment of the present invention, the PWS warning message including the CA public key information may be a PWS warning message actually for warning in the prior art, or may be a test message in the PWS warning message.

In the test message of the PWS warning message, contents of a test bit is as shown in Table 4.

TABLE 4

| Warning type Value | Warning type |
|---|---|
| 0000000 | Earthquake |
| 0000001 | Tsunami |
| 0000010 | Earthquake and Tsunami |
| 0000011 | Test |
| 0000100 | Others |
| 0000101-1111111 | Reserved for future use |

In the prior art, after a test message is received, a UE for non-test purpose discards the test message, while in the present embodiment of the present invention, if a test message is received by a UE, the UE needs to determine whether the test message includes CA public key information. If the CA public key information is included, the UE determines the CA public key information from the test message so as to update a CA public key. If CA public key information is not included, the UE discards the test message according to a processing principle in the prior art.

Step 503: the UE receives the PWS warning message, and updates a local CA public key according to the CA public key or the CA public key acquiring information in the PWS warning message.

Descriptions in step 102 may be referred to for how the UE updates the local CA public key according to the CA public key or the CA public key acquiring information in the present step, which will not be repeated redundantly herein.

In the update method as shown in FIG. 5, the CA public key or the CA public key acquiring information is carried in an existing PWS warning message and is broadcasted to the UE through the CBE, and the UE updates the local CA public key according to the CA public key or the CA public key acquiring information in the PWS warning message, thereby realizing update of the CA public key in the UE.

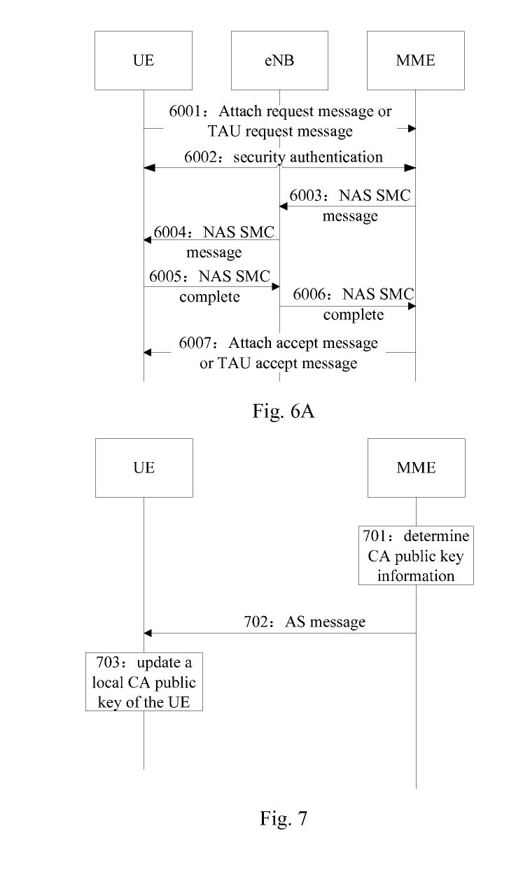

Referring to FIG. 6, a sixth embodiment of the method for updating a CA public key in the embodiments of the present invention is schematically depicted. In the present embodiment, it is taken as an example for illustration that a core network entity is an MME. As shown in FIG. 6, the method includes the following steps.

Step 601: the MME determines CA public key information.

The CA public key information may be pre-stored in the MME, and the present step may include: the MME reads the CA public key information from a corresponding storage address.

Or, the CA public key information may be included in a PWS warning message, and a CBE broadcasts the PWS warning message through a CBC. In this case, the present step may include: receiving, by the MME, a PWS warning message broadcasted by a CBE through a CBC, where the PWS warning message includes the CA public key information; and acquiring the CA public key information from the PWS warning message. The CA public key information is sent from a CA to the CBE.

Step 5001 to step 5004 in step 5A may be referred to for how the MME receives the PWS warning message broadcasted by the CBE through the CBC, which will not be repeated redundantly herein.

Step 602: the MME sends an NAS message to the UE, where the NAS message includes the CA public key information.

The NAS message may be specifically an NAS security mode command (SMC) message, an attach request message, a tracking area update (TAU) message, a routing area update (RAU) message, or a location area update (LAU) accept message.

In general, the following process needs to be performed for transmission of a NAS SMC between the UE and the MME. Referring to FIG. 6A, the process includes the following steps.

Step 6001: the UE sends an Attach request message or a TAU request message to the MME.

Step 6002: a security authentication flow is performed between the UE and the MME.

Step 6003: the MME sends the NAS SMC message to an eNB.

Step 6004: the eNB forwards the NAS SMC message to the UE.

Step 6005: the UE sends an NAS SMC complete (NAS SMC Complete) message to the eNB.

Step 6006: the eNB forwards the NAS SMC complete message to the MME.

Step 6007: the MME sends an Attach accept message or a TAU accept message to the UE.

In one implementation manner of step 602, in step 6003˜step 6004, when the MME sends the NAS SMC message to the UE through the eNB, the CA public key information is carried in the NAS SMC message. In this case, step 601 may be performed at any moment prior to step 6004, which is not limited herein.

In another implementation manner of step 602, in step 6007, the CA public key information may be carried in the Attach accept message or the TAU accept message sent from the MME to the UE. In this case, In this case, step 601 may be performed at any moment prior to step 6007, which is not limited herein.

Step 603: the UE receives the NAS message, and updates a local CA public key of the UE according to the CA public key or the CA public key acquiring information in the NAS message.

The embodiment of the present invention shown in FIG. 6 is based on an LTE system. When the embodiment of the present invention is applied to a UMTS system, an executive entity corresponding to the MME is an SGSN, and a message corresponding to the NAS SMC message is an SMC message. When the embodiment of the present invention is applied to a GSM system, an executive entity corresponding to the MME is an MSC, and a message corresponding to the NAS SMC message is a location update message.

In the update method as shown in FIG. 6, the MME determines the CA public key information, sends the CA public key information to the UE by carrying in the NAS message, and the UE updates the local CA public key according to the CA public key or the CA public key acquiring information in the CA public key information, thereby realizing update of the CA public key in the UE.

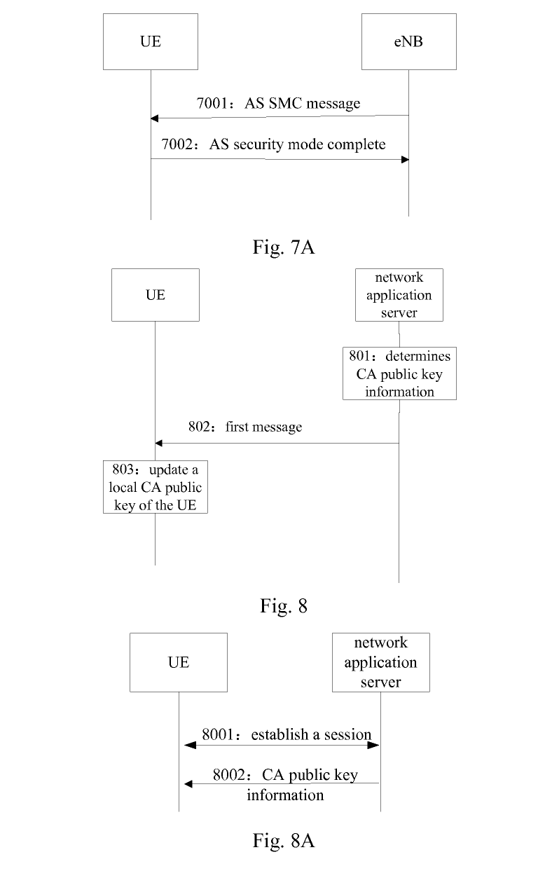

Referring to FIG. 7, a seventh embodiment of the method for updating a CA public key in the embodiments of the present invention is schematically depicted. In the present embodiment, it is taken as an example for illustration that an access network entity is an eNB. The method includes the following steps.

Step 701: the eNB determines CA public key information.

The CA public key information may be pre-stored in the eNB, and the present step may include: reading the CA public key information from a corresponding storage address.

Or, the CA public key information may be included in a PWS warning message, and a CBE broadcasts the PWS warning message through a CBC. In this case, the present step may include: receiving, by the eNB, a PWS warning message broadcasted by a CBE through a CBC, where the PWS warning message includes the CA public key information; and acquiring the CA public key information from the PWS warning message. The CA public key information is sent from a CA to the CBE.

Step 5001 to step 5004 in step 5A may be referred to for how the eNB receives the PWS warning message broadcasted by the CBE through the CBC, which will not be repeated redundantly herein.

Step 702: the eNB sends an AS message to the UE, where the AS message includes the CA public key information.

The AS message may be an AS SMC message or the like.

In general, the following process needs to be performed for transmission of a NAS SMC between the UE and the eNB. Referring to FIG. 7A, the process includes the following steps.

Step 7001: the eNB sends an AS SMC message to the UE.

Step 7002: the UE sends an AS security mode complete (AS Security Mode Complete) message to the eNB.

The AS security mode complete message may be an AS MAC message or the like.

In step 702, the eNB may carry the CA public key information in the AS SMC message in step 7001. In this case, step 701 may be performed at any moment prior to step 7001, which is not limited herein.

Step 703: the UE receives the AS message, and updates a local CA public key of the UE according to the CA public key or the CA public key acquiring information in the AS message.

In the update method as shown in FIG. 7, the eNB determines the CA public key information, sends the CA public key information to the UE by carrying in the AS message, and the UE updates the local CA public key according to the CA public key or the CA public key acquiring information in the CA public key information, thereby realizing update of the CA public key in the UE.

Referring to FIG. 8, a eighth embodiment of the method for updating a CA public key in the embodiments of the present invention is schematically depicted. The method includes the following steps.

Step 801: a network application server determines CA public key information.

The network application server refers to a server capable of providing different application programs to a client.

The network application server may be a short message service center (SMSC) or other application program server, which is not limited herein.

The CA public key information may be pre-stored in the network application server, and the present step may include: reading the CA public key information from a corresponding storage address.

Or, the CA public key information may be acquired from a CA by the network application server, and in this case, the present step may include:

acquiring, by the network application server, the CA public key from a CA through a secure connection between the network application server and the CA.

Or, the CA public key may be acquired from a certificate center by the network application server. In this case, the present step may include: acquiring the CA public key information from the certificate center.

Step 802: the network application server pushes a first message to a UE in a manner of OTA or OMA-DM at an application layer, where the first message includes the CA public key information.

Preferably, the present step may be implemented by a process as shown in FIG. 8A, including:

step 8001: establishing a session between the UE and the network application server; and

step 8002: sending the CA public key information from the network application server to the UE.

The network application server may send the CA public key information in a manner of a short message, an email and/or the like.

Correspondingly, if the CA public key information includes a CA public key, in step 803, the UE directly updates a local CA public key according to the CA public key.

If the CA public key information includes information for acquiring a CA public key, such as, for example, a link of the CA public key or an address for acquiring the CA public key, in step 803, the UE acquires the CA public key according to information for acquiring the CA public key and updates the local CA public key by using the acquired CA public key.

Step 803: the UE receives the first message and updates the local CA public key of the UE according to the CA public key or the CA public key acquiring information in the first message.

In the update method as shown in FIG. 8, the network application server determines the CA public key information, sends the CA public key information to the UE by carrying in the AS message, and the UE updates the local CA public key according to the CA public key or the CA public key acquiring information therein, thereby realizing update of the CA public key in the UE.

Corresponding to the above-mentioned methods, an embodiment of the present invention further provides an apparatus for updating a CA public key.

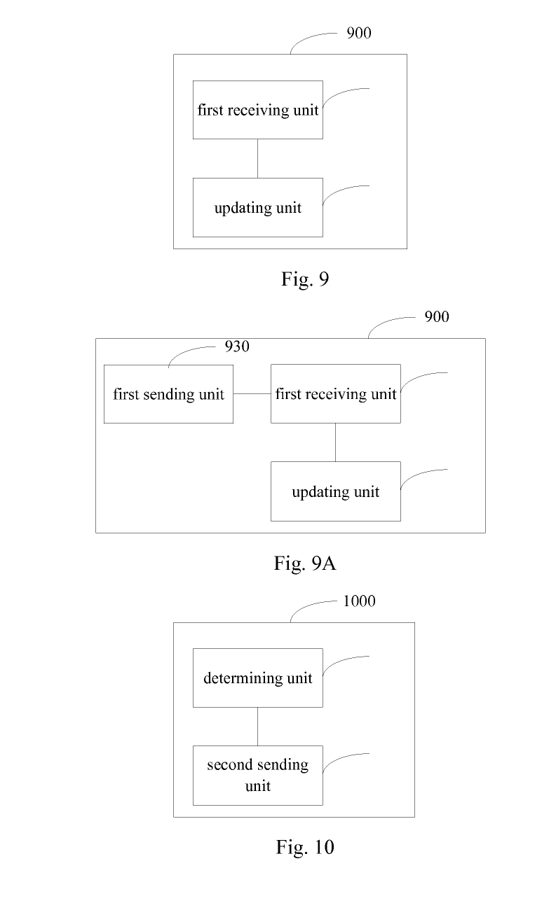

Referring to FIG. 9, a first embodiment of an apparatus for updating a CA public key in the present invention is schematically depicted. The update apparatus may be configured in a UE. The update apparatus 900 includes:

a first receiving unit 910, configured to receive a first message including CA public key information, where the CA public key information includes a CA public key or CA public key acquiring information; and

an updating unit 920, configured to update a local CA public key of a UE according to the CA public key or the CA public key acquiring information.

Preferably, referring to FIG. 9A, the update apparatus 900 may further include:

a first sending unit 930, configured to send, before the first message is received, a certificate request message in a CMPv2 protocol to a CA, where a certificate requested by the certificate request message is a CA public key;

and correspondingly, the first receiving unit 910 may be specifically configured to receive a certificate response message in the CMPv2 protocol sent by the CA, where the certificate response message includes the CA public key information.

Preferably, the first receiving unit 910 may be specifically configured to receive a CA public key update message sent by a CA, where the update message includes the CA public key information.

Preferably, the first receiving unit 910 may be specifically configured to receive a PWS warning message broadcasted by a CBE through a CBC, where the PWS warning message includes the CA public key information, and the CA public key information is sent from a CA to the CBE. In this case,

the CA public key or the CA public key acquiring information may be carried by an SIB, or carried by contents of the PWS warning message, or carried by a security information element in the PWS warning message.

The CA public key information may further include a CA public key update instruction, where the CA public key update instruction may be carried by a type information element in the PWS warning message, or carried by four idle bytes in the PWS warning message, or carried by a security information element in the PWS warning message, or carried by an SIB.

The CA public key information may further include related information of a CA public key, and the related information of the CA public key includes an ID of the CA public key and/or a period of validity of the CA public key, where the related information of the CA public key is carried by a type information element in the PWS warning message, or carried by four idle bytes in the PWS warning message, or carried by a security information element in the PWS warning message, or carried by an SIB, or carried by contents of the PWS warning message.

Preferably, the first receiving unit 910 ay be specifically configured to receive an NAS message sent by a core network entity, where the NAS message includes the CA public key information.

Preferably, the first receiving unit 910 may be specifically configured to receive an AS message sent by an access network entity, where the AS message includes the CA public key information.

Preferably, the first receiving unit 910 may be specifically configured to receive the first message pushed by a network application server in a manner of OTA or OMA-DM at an application layer, and the first message includes the CA public key information.

Preferably, the updating unit 920 may be specifically configured to update, when the CA public key information includes the CA public key, the local CA public key of the UE according to the CA public key.

Or, the CA public key information includes the CA public key acquiring information, and the CA public key acquiring information is a download link of a CA public key, the updating a local CA public key of a UE according to the CA public key acquiring information, includes:

downloading the CA public key through the download link of the CA public key, and updating the local CA public key by using the downloaded CA public key.

Or, the CA public key information includes the CA public key acquiring information, and the CA public key acquiring information is an address for acquiring a CA public key, the updating a local CA public key of a UE according to the CA public key acquiring information, includes:

acquiring the CA public key from the address for acquiring the CA public key, and updating the local CA public key by using the acquired CA public key.

Preferably, the updating unit 920 may be further configured to determine that the first message includes a CA public key update instruction before updating the CA public key.

In the update apparatus as shown in FIG. 9 and FIG. 9A, the first receiving unit 910 receives the first message including the CA public key information, and the updating unit 920 updates the local CA public key of the UE according to the CA public key or the CA public key acquiring information, thereby realizing update of the CA public key in the UE.

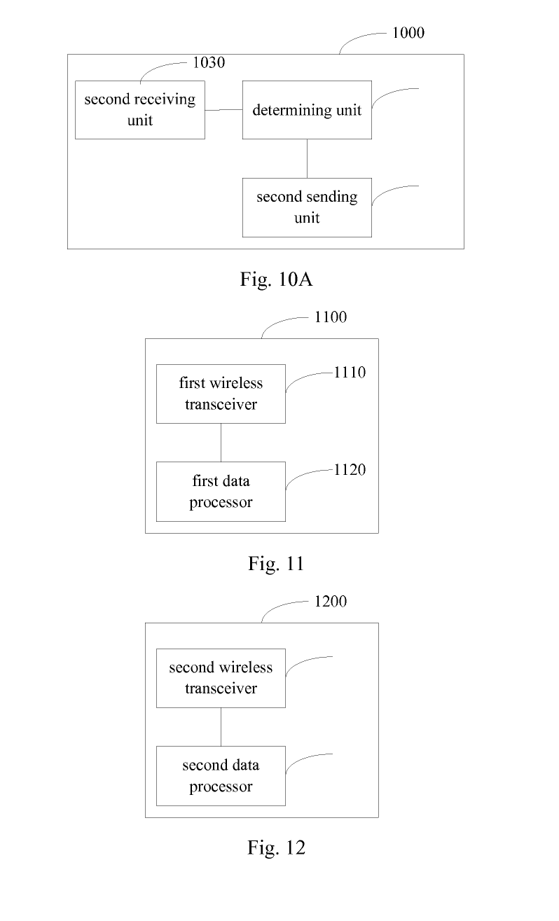

Referring to FIG. 10, a third embodiment of the apparatus for updating a CA public key in the present invention is schematically depicted. The update apparatus may be configured in a CA, a core network entity, an access network entity or a network application server. The update apparatus 1000 may include:

a determining unit 1010, configured to determine CA public key information, where the CA public key information includes a CA public key or CA public key acquiring information; and

a second sending unit 1020, configured to send a first message including the CA public key information determined by the determining unit 1010 to a UE, where the first message is used for updating a local CA public key of the UE.

When the update apparatus is applied to a CA,

preferably, referring to FIG. 10 A, the update apparatus 900 may further include:

a second receiving unit 1030, configured to receive, before the determining unit 1010 determines the CA public key information, a certificate request message in a CMPv2 protocol sent by the UE, where a certificate requested by the certificate request message is a CA public key;

and correspondingly, the second receiving unit 1020 may be specifically configured to send a certificate response message in the CMPv2 protocol to the UE, where the certificate response message includes the CA public key information.

Preferably, the second receiving unit 1020 may be specifically configured to send a CA public key update message to the UE, where the CA public key update message includes the CA public key information.

Preferably, the second receiving unit 1020 may be specifically configured to send the CA public key information to a CBE, such that the CBE broadcasts a PWS warning message through a CBC, where the PWS warning message includes the CA public key information.

When the updating apparatus is applied to a core network entity, a access network entity or a network application server,

preferably, the determining unit 1010 may include:

a first receiving subunit, configured to receive a PWS warning message broadcast by a CBE through a CBC, where the PWS warning message includes the CA public key information, and the CA public key information is sent from a CA to the CBE; and

a first acquiring subunit, configured to acquire the CA public key information from the PWS warning message.

When the update apparatus is applied to the core network entity,

preferably, the second receiving unit 1020 may be specifically configured to send an NAS message to the UE, where the NAS message includes the CA public key information.

When the update apparatus is applied to the access network entity,

preferably, the second receiving unit 1020 may be specifically configured to send an AS message to the UE, where the AS message includes the CA public key information.

When the PWS warning message includes the CA public key information,

the CA public key or the CA public key acquiring information may be carried by an SIB, or carried by contents of the PWS warning message, or carried by a security information element in the PWS warning message.

The CA public key information further includes a CA public key update instruction, where the CA public key update instruction is carried by a type information element in the PWS warning message, or carried by four idle bytes in the PWS warning message, or carried by a security information element in the PWS warning message, or carried by an SIB.

The CA public key information further includes related information of a CA public key, where the related information of the CA public key includes an ID of the CA public key and/or a period of validity of the CA public key, and the related information is carried by a type information element in the PWS warning message, or carried by four idle bytes in the PWS warning message, or carried by a security information element in the PWS warning message, or carried by an SIB, or carried by contents of the PWS warning message.

When the update apparatus is applied to the network application server,

preferably, the second receiving unit 1020 may be specifically configured to push the first message to the UE in a manner of OTA or OMA-DM at an application layer, where the first message includes the CA public key information.

The apparatus in the present embodiment may cooperate with the apparatus applied to the UE in sending the CA public key information to the UE, so as to update the CA public key in the UE.

An embodiment of the present invention further provides a UE. Reffering to FIG. 11, UE 1100 includes:

a first wireless transceiver 1110, configured to receive a first message including CA public key information, where the CA public key information includes a CA public key or CA public key acquiring information; and

a first data processor 1120, configured to update a local CA public key of the UE according to the CA public key or the CA public key acquiring information.

Preferably, the first wireless transceiver 1110 may be further configured to send, before the first message is received, a certificate request message in a CMPv2 protocol to a CA, where a certificate requested by the certificate request message is a CA public key;

and correspondingly, the first wireless transceiver 1110 may be specifically configured to receive a certificate response message in the CMPv2 protocol sent by the CA, where the certificate response message includes the CA public key information.

Preferably, the first wireless transceiver 1110 may be specifically configured to receive a CA public key update message sent by a CA, where the update message includes the CA public key information.

Preferably, the first wireless transceiver 1110 may be specifically configured to receive a PWS warning message broadcasted by a CBE through a CBC, where the PWS warning message includes the CA public key information, and the CA public key information is sent from a CA to the CBE.

Preferably, the CA public key or the CA public key acquiring information may be carried by an SIB, or carried by contents of the PWS warning message, or carried by a security information element in the PWS warning message.

Preferably, the CA public key information further includes a CA public key update instruction, where the CA public key update instruction is carried by a type information element in the PWS warning message, or carried by four idle bytes in the PWS warning message, or carried by a security information element in the PWS warning message, or carried by an SIB.

Preferably, the CA public key information further includes related information of a CA public key, where the related information of the CA public key includes an ID of the CA public key and/or a period of validity of the CA public key, where the related information of the CA public key is carried by a type information element in the PWS warning message, or carried by four idle bytes in the PWS warning message, or carried by a security information element in the PWS warning message, or carried by an SIB, or carried by contents of the PWS warning message.

Preferably, the first wireless transceiver 1110 may be specifically configured to receive an NAS message sent by a core network entity, where the NAS message includes the CA public key information.

Preferably, the first wireless transceiver 1110 may be specifically configured to receive an AS message sent by an access network entity, where the AS message includes the CA public key information.

Preferably, the first wireless transceiver 1110 may be specifically configured to receive the first message pushed by a network application server in a manner of OTA or OMA-DM at an application layer, where the first message includes the CA public key information.

Preferably, the first processor 1120 may be specifically configured to update, when the CA public key information includes the CA public key, the local CA public key of the UE according to the CA public key.

Or, the CA public key information includes the CA public key acquiring information, and when the CA public key acquiring information is a download link of the CA public key, the updating a local CA public key of a UE according to the CA public key acquiring information, includes:

downloading the CA public key through the download link of the CA public key, and updating the local CA public key by using the downloaded CA public key;

Or, the CA public key information includes the CA public key acquiring information, and when the CA public key acquiring information is an address for acquiring a CA public key, the updating a local CA public key of a UE according to the CA public key acquiring information, includes:

acquiring the CA public key from the address for acquiring the CA public key, and updating the local CA public key by using the acquired CA public key.

Preferably, the first processor 1120 may be further configured to determine that the first message includes a CA public key update instruction before updating the CA public key.

In the present embodiment, the first wireless transceiver 1110 receives the first message including the CA public key information, the CA public key information including the CA public key or the CA public key acquiring information, and the first data processor 1120 updates the local CA public key of the UE according to the CA public key or the CA public key acquiring information, thereby realizing update of the CA public key in the UE.

An embodiment of the present invention further provides a CA. Referring to FIG. 12, CA 1200 includes:

a second data processor 1210, configured to determine CA public key information, where the CA public key information includes a CA public key or CA public key acquiring information; and

a second wireless transceiver 1220, configured to send a first message including the CA public key information determined by the second data processor 1210 to a UE, where the first message is used for updating a local CA public key of the UE.

Preferably, the second wireless transceiver 1220 may be further configured to receive, before the second data processor 1210 determines the CA public key information, a certificate request message in a CMPv2 protocol sent by the UE, where a certificate requested by the certificate request message is a CA public key;

and correspondingly, the second wireless transceiver 1220 may be specifically configured to send a certificate response message in the CMPv2 protocol to the UE, where the certificate response message includes the CA public key information.

Preferably, the second wireless transceiver 1220 may be specifically configured to send a CA public key update message to the UE, where the CA public key update message includes the CA public key information.

Preferably, the second wireless transceiver 1220 may be specifically configured to send the CA public key information to a CBE, such that the CBE broadcasts a PWS warning message through a CBC, where the PWS warning message includes the CA public key information.

In the present embodiment, the CA may cooperate with the UE in updating the CA public key in the UE.

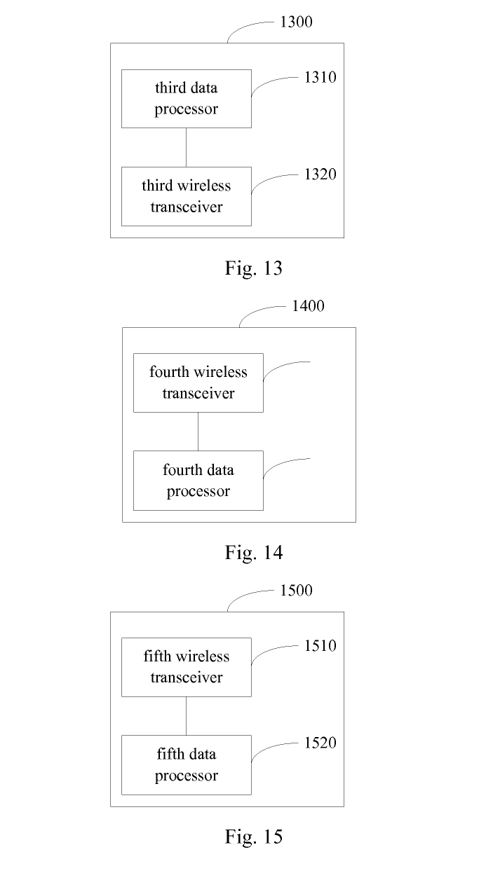

An embodiment of the present invention further provides a core network entity. Referring to FIG. 13, the core network entity 1300 includes:

a third data processor 1310, configured to determine CA public key information, where the CA public key information includes a CA public key or CA public key acquiring information; and

a third wireless transceiver 1320, configured to send a first message including the CA public key information determined by the third data processor 1310 to a UE, where the first message is used for updating a local CA public key of the UE.

Preferably, the third wireless transceiver 1320 may be further configured to receive a PWS warning message broadcasted by a CBE through a CBC, where the PWS warning message includes the CA public key information, and the CA public key information is sent from a CA to the CBE; and

the third data processor 1310 may be specifically configured to acquire the CA public key information from the PWS warning message.

Preferably, the third wireless transceiver 1320 may be further configured to send an NAS message to the UE, where the NAS message includes the CA public key information.

In the present embodiment, the core network entity may cooperate with the UE in updating the CA public key in the UE.

An embodiment of the present invention further provides an access network entity. Referring to FIG. 14, the access network entity 1400 includes:

a fourth data processor 1410, configured to determine CA public key information, where the CA public key information includes a CA public key or CA public key acquiring information; and

a fourth wireless transceiver 1420, configured to send a first message including the CA public key information determined by the fourth data processor 1410 to a UE, where the first message is used for updating a local CA public key of the UE.

Preferably, the fourth wireless transceiver 1420 may be further configured to receive a PWS warning message broadcasted by a CBE through a CBC, where the PWS warning message includes the CA public key information, and the CA public key information is sent from a CA to the CBE; and

the fourth data processor 1410 may be specifically configured to acquire the CA public key information from the PWS warning message.

Preferably, the fourth data processor 1420 may be further configured to send an AS message to the UE, where the AS message includes the CA public key information.

In the present embodiment, the access network entity may cooperate with the UE in updating the CA public key in the UE.

An embodiment of the present invention further provides a network application server. Referring to FIG. 15, the network application server 1500 includes:

a fifth data processor 1510, configured to determine CA public key information, where the CA public key information includes a CA public key or CA public key acquiring information; and

a fifth wireless transceiver 1520, configured to send a first message including the CA public key information determined by the fifth data processor 1510 to a UE, where the first message is used for updating a local CA public key of the UE.

Preferably, the fifth wireless transceiver 1520 is specifically configured to push the first message to the UE in a manner of OTA or OMA-DMat an application layer, where the first message includes the CA public key information.

In the present embodiment of the present invention, the network application server may cooperate with the UE in updating the CA public key in the UE.

Those skilled in the art may clearly appreciated that the technologies in the embodiments of the present invention may be implemented by a software plus a necessary universal hardware platform. Based on such understanding, the technical solutions in the embodiments of the present invention, in essence or the part contributing to the prior art, may be embodied in a form of a software product. The computer software product may be stored in a storage medium such as, for example, an ROM/RAM, a magnetic disk, an optical disk or the like, which includes several instructions for instructing a computer device (may be a personal computer, a server, or network equipment or the like) to perform the respective embodiments of the present invention, or perform the methods described in certain part of an embodiment.

The respective embodiments in the description are described in a progressive manner, and identical or similar parts between the respective embodiments may refer to each other. The description on each embodiment is focus on differences of the embodiment from other embodiment. In particular, for a system embodiment, since it is basically similar to the method embodiments, it is described simply and part of the descriptions in the method embodiments may be referred to for related parts.

The foregoing implementation manners of the present invention described above are not limiting the protection scope of the present invention. Any modifications, equivalent substitutions, improvements and/or the like within the spirit and principle of the present invention shall fall into the protection scope of the present invention.

What is claimed is:

1. A method for updating a certification authority (CA) public key, comprising:
receiving a first message comprising CA public key information, wherein the CA public key information comprises one of a CA public key and CA public key acquiring information; and
updating the a local CA public key of a UE according to the one of the CA public key and the CA public key acquiring information.

2. The method of claim 1, wherein the receiving a first message comprising CA public key information, comprises:
receiving a PWS warning message broadcasted by a CBE through a CBC, wherein the PWS warning message comprises the CA public key information, and the CA public key information is sent from a CA to the CBE.

3. The method of claim 2, wherein the one of the CA public key and the CA public key acquiring information is carried by one of the following: an SIB, contents of the PWS warning message, and a security information element in the PWS warning message.

4. The method of claim 2, wherein the CA public key information further comprises a a CA public key update instruction, and the CA public key update instruction is carried by one of the following: a type information element in the PWS warning message, four idle bytes in the PWS warning message, a security information element in the PWS warning message, and an SIB.

5. The method of claim 2, wherein the CA public key information further comprises related information of a CA public key, and the related information of the CA public key comprises at least one of an ID of the CA public key and a period of validity of the CA public key, wherein the related information of the CA public key is carried by one of the following: a type information element in the PWS warning message, four idle bytes in the PWS warning message, a security information element in the PWS warning message, an SIB, and contents of the PWS warning message.

6. The method of claim 1, wherein the receiving a first message comprising CA public key information, comprises:
receiving an NAS message sent by a core network entity, wherein the NAS message comprises the CA public key information.

7. The method of claim 1, wherein the receiving a first message comprising CA public key information, comprises:
receiving an AS message sent by an access network entity, wherein the AS message comprises the CA public key information.

8. The method of claim 1, wherein the receiving a first message comprising CA public key information, comprises:
receiving the first message pushed by a network application server in a manner of one of OTA and OMA-DM at an application layer, wherein the first message comprises the CA public key information.

9. The method of claim 1, wherein one of the following conditions is satisfied:
when the CA public key information comprises the CA public key, the local CA public key of the UE is updated according to the CA public key;
the CA public key information comprises the CA public key acquiring information, and when the CA public key acquiring information is a download link of the CA public key, the updating a local CA public key of a UE according to the CA public key acquiring information, comprises:
downloading the CA public key through the download link of the CA public key, and updating the local CA public key by using the downloaded CA public key;
the CA public key information comprises the CA public key acquiring information, and when the CA public key acquiring information is an address for acquiring a CA public key, the updating a local CA public key of a UE according to the CA public key acquiring information, comprises:
acquiring the CA public key from the address for acquiring the CA public key, and updating the local CA public key by using the acquired CA public key.

10. A method for updating a certification authority (CA) public key, comprising:
determining CA public key information, wherein the CA public key information comprises one of a CA public key and CA public key acquiring information; and
sending a first message comprising the CA public key information to a UE, wherein the first message is used for updating a local CA public key of the UE.

11. The method of claim 10, wherein the sending a first message comprising CA public key information to a UE, comprises:
sending a CA public key update message to the UE, wherein the CA public key update message comprises the CA public key information.

12. The method of claim 10, wherein the sending a first message comprising CA public key information to a UE, comprises:
sending the CA public key information to a CBE, such that the CBE broadcasts a PWS warning message through a CBC, wherein the PWS warning message comprises the CA public key information.

13. The method of claim 10, wherein the determining CA public key information comprises:
receiving a PWS warning message broadcasted by a CBE through a CBC, wherein the PWS warning message comprises the CA public key information, and the CA public key information is sent from a CA to the CBE; and
acquiring the CA public key information from the PWS warning message.

14. The method of claim 10, wherein the sending a first message comprising the CA public key information to a UE, comprises:
sending an NAS message to the UE, wherein the NAS message comprises the CA public key information.

15. The method of claim 10, wherein the sending a first message comprising the CA public key information to a UE, comprises:
sending an AS message to the UE, wherein the AS message comprises the CA public key information.

16. The method of claim 12, wherein when the PWS warning message comprises the CA public key information, the one of the CA public key and the CA public key acquiring information is carried by one of the following: an SIB, contents of the PWS warning message, and a security information element in the PWS warning message.

17. The method of claim 12, wherein when the PWS warning message comprises the CA public key information,
the CA public key information further comprises a CA public key update instruction, wherein the CA public key update instruction is carried by one of the following: a type information element in the PWS warning message, four idle bytes in the PWS warning message, a security information element in the PWS warning message, and an SIB.

18. The method of claim 12, wherein when the PWS warning message comprises the CA public key information,
the CA public key information further comprises related information of a CA public key, wherein the related information of the CA public key comprises at least one of an ID of the CA public key and a period of validity of the CA public key, and the related information is carried by one of the following: a type information element in the PWS warning message, four idle bytes in the PWS warning message, a security information element in the PWS warning message, an SIB, and contents of the PWS warning message.

19. The method of claim 10, wherein the sending a first message comprising the CA public key information to a UE, comprises:
pushing the first message to the UE in a manner of one of OTA and OMA-DM at an application layer, wherein the first message comprises the CA public key information.

20. An apparatus for updating a certification authority (CA) public key, comprising:
a first wireless transceiver, configured to receive a first message comprising CA public key information, wherein the CA public key information comprises one of a CA public key and CA public key acquiring information; and
a first data processor, configured to update a local CA public key of a UE according to the one of the CA public key and the CA public key acquiring information.
